(19) United States
(12) Patent Application Publication
(10) Pub. No.: US 2026/0064775 A1
(43) Pub. Date: Mar. 5, 2026

(54) Creating and Using a Graph of Organisation-Specific Knowledge From Conversation Data

(71) Applicant: Dubber Pty Ltd, Burwood (AU)

(72) Inventors: Iain McCowan, Ashmore (AU); Neville Ball, Epping (AU); Jaco du Plessis, Upper Coomera (AU); Darren Moore, Stafford Heights (AU)

(21) Appl. No.: 19/316,512

(22) Filed: Sep. 2, 2025

(30) Foreign Application Priority Data
Sep. 3, 2024 (AU) 2024902767

(51) Int. Cl. G06F 16/901; G06F 7/14; G06F 40/284; G06F 40/289; G06F 40/40

(52) U.S. Cl. CPC G06F 16/9024; G06F 7/14; G06F 40/284; G06F 40/289; G06F 40/40

(57) ABSTRACT

A computer-implemented method of building a graph of organisation-specific knowledge includes the step of receiving conversation data. Words and phrases within the conversation data that describe organisational knowledge are detected. Sets of candidate knowledge tuples are extracted. Each tuple includes a sequence of elements that represent respective words, phrases, or sentences that describe an item of knowledge. The elements in each tuple are ordered according to an ontology of the item of knowledge. The tuples in each set describe respective versions of the item of organisational knowledge. Exemplar tuples that correspond to candidate tuples in respective sets that contain elements that occur more than a threshold number of times in the text are created. The graph is initialised from nodes representing the elements of the exemplar tuples. Edges represent relationships between the elements. Sets of nodes that represent the same element of organisational knowledge are progressively determined and merged into exemplary nodes.

### CROSS REFERENCE TO RELATED PATENTS

In this specification, reference is made to U.S. Pat. No. 11,950,020 ('020). The entire contents of '020 is incorporated herein by reference.

### TECHNICAL FIELD

This invention relates to the creation and use of a graph of organisation-specific knowledge from conversation data.

### BACKGROUND

'020 describes a method of visualising a meeting between one or more participants. The method includes generating features, and phase and event indicators associated with the features. The generation of the features and indicators may result in those features and indicators including content such as hold message content, which is not ideal. Furthermore, it has been determined that it would be desirable to associate the features and indicators, such as complaints about product quality, with organisational knowledge or information, such as the relevant product.

Different types of organisational knowledge should be known to understand a business conversation. For example, it may be beneficial to be aware of different types of organisational knowledge when capturing data representing a conversation.

It may be useful to disregard or skip over parts of the conversation that are repetitive organisational knowledge, such as hold messages, standard legal disclaimers, etc.

It may be beneficial to annotate a conversation transcript according to organisational knowledge, such as names of products, services, and departments to facilitate routing, indexing, and retrieval of conversation data.

Organisational knowledge should be reliably detected within conversation data to achieve any benefits. Presently, such knowledge may not be available for input, or it may be infeasible or too onerous for a human user to input such data.

An organisation may have a set of programmatic messages that are injected into telephone or conference calls to allow a caller to be routed to a particular department, or to listen to marketing content while on hold. This may be achieved with recorded messages, or with boilerplate text that is read by a human or a synthesised agent.

Examples of such messages may include:
Interactive Voice Response (IVR) messages prompting callers to select an option via a key press,
information about a business, such as opening hours and location,
promotional content about products or services,
legal disclaimers,
standard terms and conditions,
recording notifications, and
conference participant notifications.

These messages do not form part of a conversation with a customer. It may be advantageous for the content of these messages to be disregarded for the purposes of analysis, retrieval, browsing, or playback of the conversation. Similarly, in a conversation intelligence use case analysing a call for key moments or topics, as described in '020, the programmatic message content should not influence the results. It may be beneficial to skip over these parts when reviewing a textual, audio, or video record of a conversation.

Several high-level factors complicate the task of disregarding the message content, including the factors listed below.
In general, the message content for a given organisation will vary over time. For example, promotional hold messages may mention seasonal promotional offers or information about upcoming events.
On a given call, multiple messages may be played for several purposes, such as recording notification and promotional purposes.
For an organisation distributed across multiple geographic locations, the message content may vary by location-such as message content related to store location and opening hours.
Different departments or divisions in an organisation may have specific, respective messages related to their context.
There may be a plurality of messages available for the organisation from which one is chosen to play at a particular time, such as promotions for different products.
The context of a particular call may influence which message is played, when it is played within the call, and how much of the message is played.
Automatic speech-to-text transcription may involve some errors, creating variations in how a given message is transcribed between different calls.
Speech from call participants may overlap with the message, such as background speech while they are waiting on hold.

These factors mean that there may be a large set of distinct messages that varies over time, and an unknown portion of these messages may be played at different times in a call.

Due to the potential large set of messages and the variation over time and location, it may be onerous to require a user to configure a system with the full set of messages to be disregarded, and to maintain this in a consistent up-to-date state.

Another form of organisational knowledge in conversations may be the set of products and/or services the organisation offers. These may be referred to during customer sales conversations, complaints, or general enquiries.

Understanding when a term in a conversation is referring to a product or service and having these automatically detected in the conversation may have several practical benefits. For example, it may allow the organisation to understand which products are requested more frequently in sales conversations, or services that have a higher rate of complaint calls. In a real-time scenario, it may also help automatically to route calls to the correct department.

Detecting when a product or service has been mentioned in a conversation may be complex for several reasons set out below.
In general, the set of products and services for a given organisation may vary over time, as would result from the release of new models or business expansion.
Each different department, division, or geographical location may offer a distinct set of products or services.
Automatic speech-to-text transcription may involve some errors, creating variations in how a given product or service name is transcribed between different calls. For example, brand names or model names are more likely to be incorrectly transcribed than general language.
People may express the same product or service using different words. Disambiguating such variation can be problematic because different products or services may have very similar names, differing only in a number or small word, and yet need to be understood as distinct. It is therefore difficult to readily determine if a term is a spoken or incorrectly transcribed variation of the same product or is a distinct product.

The potential large set of products and services, the variation over time and location, as well as the multiple ways the same products and services may be described or transcribed in a natural conversation, makes this a complex problem. It may be onerous to ask a user manually to ensure that a system has up to date knowledge of all products and services and, even if this were possible, using simple keyword matching or more complex semantic similarity measures cannot readily resolve the disambiguation for the reasons listed above.

A further form of organisational knowledge that may be referred to in conversations relates to the structure of the organisation and the people within it. This could include departments, divisions, teams, roles, job titles, and names of teams or individuals. The knowledge may also include relationships between these-such as a role within a department, or the name of an individual with a particular role.

Automatically building knowledge about the organisation structure from conversations may be beneficial for several reasons. It may ensure calls being directed to the appropriate department. It may also facilitate understanding a person's role when their name is mentioned.

Depending on the type of organisation, there may be many other forms of organisational knowledge referred to in conversations. These could include, for example, technology systems, names of partner organisations, processes, etc.

Detecting when words in a conversation are referring to these elements of organisational knowledge or context may be advantageous for correctly understanding, interpreting, filing or routing conversation data.

### SUMMARY

According to an aspect, there is provided a computer-implemented method of building a graph of organisation-specific knowledge, the method comprising the steps of:
receiving conversation data representing at least one conversation;
detecting words and phrases within the conversation data that describe organisational knowledge;
extracting sets of candidate knowledge tuples from the conversation data, each tuple including a sequence of elements that represent respective words, phrases, or sentences that together describe an item of organisational knowledge, the elements in each tuple being ordered according to an ontology of the item of organisational knowledge, and the tuples in each set describing respective versions of the item of organisational knowledge;
creating exemplar tuples that correspond to candidate tuples in respective sets that contain elements that occur more than a threshold number of times in the text;
initialising the graph from nodes representing the elements of the exemplar tuples, and edges representing relationships between the elements; and
progressively determining and merging sets of nodes that represent the same element of organisational knowledge into exemplary nodes of the graph.

The step of detecting words and phrases within the text that describe the items of organisational knowledge may include the step of using natural language processing to identify the words, phrases or sentences.

The different types of organisational knowledge may include one or more of the following:
programmatic messages inserted into conversations, along with their type such as on hold messages, IVR responses, legal disclaimers, terms and conditions, etc.;
products or services provided by the organisation;
organisational structure such as departments, roles, and personnel; and
other organisational knowledge that provides context to conversations, such as systems, processes, industry details, partner organisations, etc.

The step of detecting words and phrases within the text may include the step of using a neural network language model. The step of using a neural network language model may include the step of using a supervised classifier that is trained to discriminate between sentences containing organisational knowledge and normal conversational speech sentences by using an annotated set of sentences containing known organisational knowledge as well as normal conversational speech.

The text representing the detected words and phrases may be normalised to facilitate upstream comparisons.

The ontology of each item of organisational knowledge may be hierarchical such that elements of each candidate tuple are sequenced in hierarchical order with each candidate tuple having the form {“Level 1”, “Level 2”; “Level 3”; . . . , “Level N”}, where Level 1 is a broadest category of the item of organisational information, and Level N is a narrowest category.

The step of initialising the graph may include the steps of:
a) for each candidate tuple from a counted set of candidate tuples having an occurrence that is greater than the threshold number, creating a new Level 1 node for each unique Level 1 field;
b) for each candidate tuple with a given Level 1 field, creating a Level 2 node connected to a corresponding Level 1 node for each unique Level 2 field;
c) for each candidate tuple with a given Level 1 and Level 2 field combination, creating a Level 3 node connected to a corresponding Level 2 node for each unique Level 3 field;
d) repeating steps (a) to (c) until all tuple levels have been processed; and
e) for each node, storing the corresponding count from the counted set as metadata.

The nodes that represent the same element of organisational knowledge may be associated with the exemplary node as metadata to facilitate matching in subsequent detection processes and may be subsequently pruned from the graph to reduce its complexity.

A determination of whether any two nodes represent the same element of organisational knowledge may be carried out by transforming the associated candidate tuples into vectors in an embedding space and measuring a distance between the two vectors or measuring cosine similarity between the two vectors.

A determination of whether any two nodes represent the same element of organisational knowledge may be carried out by deducing similarity using neural network language models.

A model of the graph may be trained by:
a) determining an occurrence count threshold for which it is assumed that elements of organisational knowledge above this count are good quality exemplars; and
b) merging lower occurrence elements into the higher occurrence elements if predetermined similarity conditions are met.

A model may be trained by:
a) determining a similarity threshold; and
b) merging the most similar elements above a predetermined occurrence threshold until no possible mergers lie above the similarity threshold.

According to an aspect, there is provided a method of determining organisational knowledge using the graph built according to the method described above, the method comprising the steps of:
providing a transcript representing at least one conversation;
detecting elements of organisational knowledge in the transcript by performing a matching function to measure a similarity between the elements of organisational knowledge in the transcript and the elements of organisational knowledge represented by the nodes of the graph; and
outputting detected elements of organisational knowledge as metadata associated with the at least one conversation.

The step of performing the matching function may include the step of computing a similarity between TF-IDF vector representations of test elements of organisational knowledge from the transcript and exemplar elements of organisational knowledge from the graph.

The step of computing the similarity between the TF-IDF vector representations may include the steps of:
a) using an NLP tokenizer or embedding network to convert the transcript and exemplar elements of organisational knowledge into vectors of length M, representing a number of possible tokens;
b) converting N exemplar elements of organisational knowledge into numerical TF-IDF form to generate an N×M matrix;
c) converting T transcription elements of organisational knowledge into numerical TF-IDF form to generate a T×M matrix; and
d) computing the similarity between the matrices.

The step of computing the similarity between the matrices may include the step of computing a cosine similarity between all combinations of transcript and exemplar elements of organisational knowledge.

The step of computing the similarity between the matrices may be carried out using sparse matrix representations.

According to an aspect, there is provided a system for building a graph of organisation-specific knowledge, the system comprising:
a non-transitory computer-readable medium with instructions encoded thereon; and
one or more processors configured to, when executing the instructions, perform operations of:
   receiving conversation data representing at least one conversation;
detecting words and phrases within the conversation data that describe organisational knowledge;
   extracting sets of candidate knowledge tuples from the conversation data, each tuple including a sequence of elements that represent respective words and phrases that together describe an item of organisational knowledge, the elements in each tuple being ordered according to an ontology of the item of organisational knowledge, and the tuples in each set describing respective versions of the item of organisational knowledge;
   creating exemplar tuples that correspond to candidate tuples in respective sets that contain elements that occur more than a threshold number of times in the text;
   Initialising the graph from nodes representing the elements of the exemplar tuples; and
   progressively determining and merging sets of nodes that represent the same element of organisational knowledge into exemplary nodes of the graph.

According to an aspect of the invention, there is provided a computer program product comprising a non-transitory computer-readable storage medium containing computer program code, the computer program code, when executed by one or more processors causing the one or more processors to perform operations, the computer program code comprising instructions to:
receive conversation data representing at least one conversation;
detect words and phrases within the conversation data that describe organisational knowledge;
extract sets of candidate knowledge tuples from the conversation data, each tuple including a sequence of elements that represent respective words and phrases that together describe an item of organisational knowledge, the elements in each tuple being ordered according to an ontology of the item of organisational knowledge, and the tuples in each set describing respective versions of the item of organisational knowledge;
create exemplar tuples that correspond to candidate tuples in respective sets that contain elements that occur more than a threshold number of times in the text;
initialise the graph from nodes representing the elements of the exemplar tuples; and
progressively determine and merge sets of nodes that represent the same element of organisational knowledge into exemplary nodes of the graph.

### BRIEF DESCRIPTION OF THE DRAWINGS

FIG. 1 is a flowchart of an embodiment of a computer implemented method for building a graph of organisation-specific knowledge.

FIG. 2 is a block diagram illustrating use of a data extraction module inside one embodiment of a system for building a graph of organisation-specific context, in accordance with the invention.

FIG. 3 is a block diagram illustrating use of the data extraction module of FIG. 2 in more detail.

FIG. 4 is a flowchart of an embodiment of a computer implemented method for building the graph from candidate tuples extracted from conversation data.

FIG. 5 is a graph built in accordance with the method represented by the flowchart of FIG. 4.

FIG. 6 is a block diagram illustrating use of a detection module for detecting organisation-specific information or knowledge in conversation data using a graph of organisation-specific knowledge.

FIG. 7 is a block diagram of an embodiment of a system, in accordance with the invention, for building and using a graph of organisation-specific knowledge.

FIG. 8 is a schematic diagram of an embodiment of an electronic processing device configured to carry out a computer implemented method for building and using a graph of organisation-specific knowledge.

FIG. 9 is an example of an output generated when using the graph of organisation-specific knowledge.

FIG. 10 is an example of an output generated when using the graph of organisation-specific knowledge.

### DETAILED DESCRIPTION

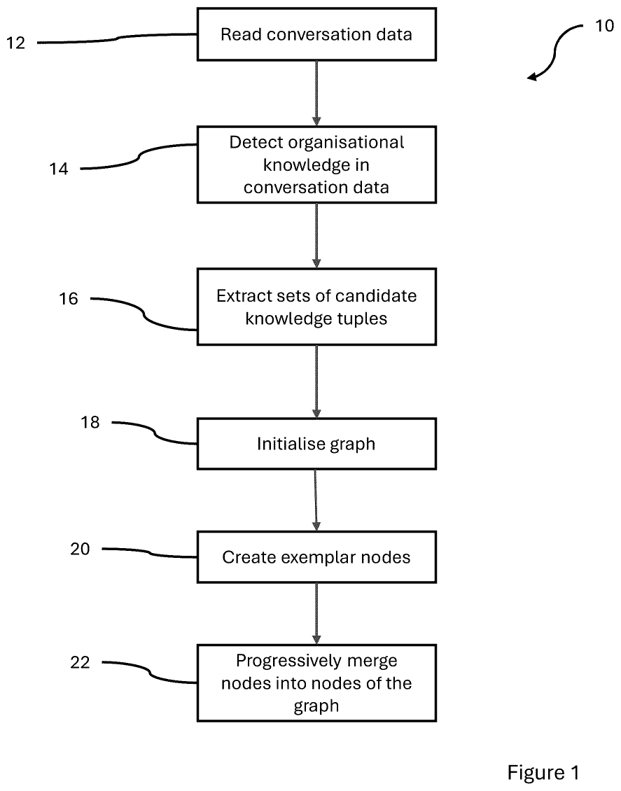

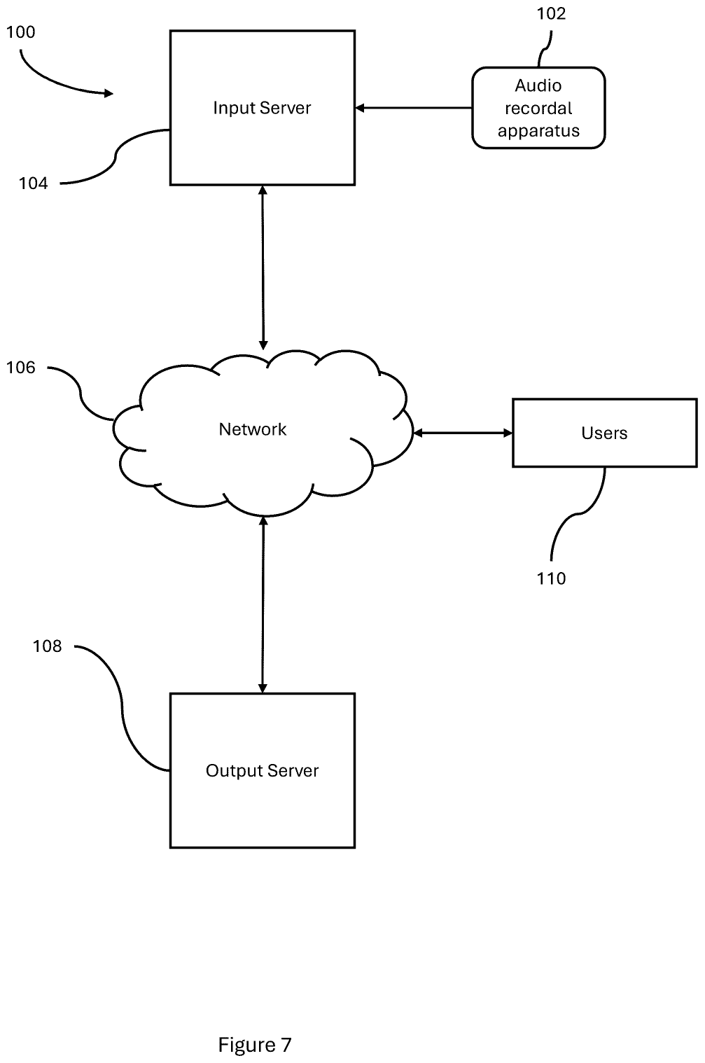

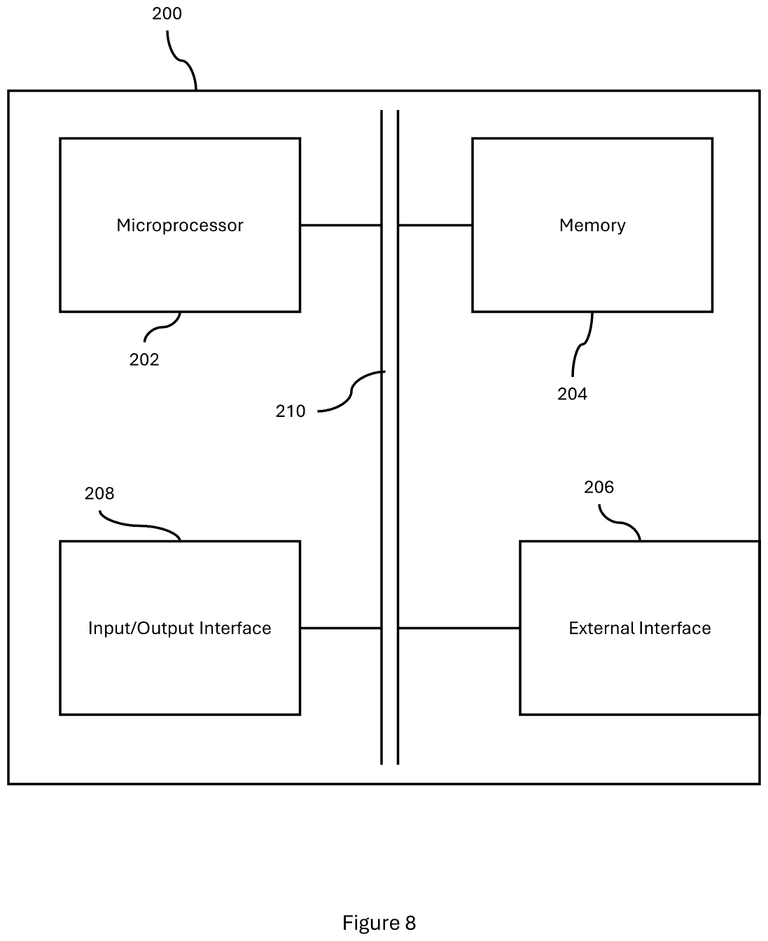

In FIG. 1, reference numeral 10 generally indicates a flowchart of one embodiment of a computer-implemented method for building a graph of organisation-specific knowledge from conversation data. The method is performed by an embodiment of a system 100 (FIG. 7). The method can also be performed by an electronic processing device 200 (FIG. 8).

A graph can represent semantics by describing entities or elements of knowledge and their relationships to each other. The elements of knowledge are nodes in the graph, while the relationships are edges in the graph. A graph can use ontologies as a schema layer. The graph can facilitate the retrieval of implicit knowledge in addition to explicit knowledge from data, such as text, stored in a database. The graph can be iteratively updated with subsequent information input into the database. It follows that the graph can be used in various machine learning tasks.

The method described herein creates a graph of organisation-specific context or information automatically by analysing conversation data. The graph is built or constructed by analysing recurring words and phrases across multiple conversations. No prior configuration is required. The graph encodes organisational knowledge that occurs in conversations, such as a telephone conversation between an employee and a customer for use in annotating subsequent conversation data.

Nodes in the graph encode entities that are individual elements of organisational knowledge, such as a marketing message or advertising promotion, the name of a product or service, or roles and departments within the organisation. Edges in the graph encode relationships between the entities, such as hierarchical relationships. For example, the edges can link individual product modules within a given brand. In turn, multiple brands can be joined together under different product types.

The elements of organisational knowledge can be one or more of the elements in the following non-exhaustive list:
programmatic messages inserted into conversations, such as on hold messages,
details of products or services provided by the organisation,
organisational structures such as departments, people and roles, and
other organisational knowledge that provides context to conversations, such as systems, processes, industry details, partner organisations, etc.

A data processing apparatus such as a server or processor reads conversation data at step 12. This can be achieved in various ways. For example, a module executed by the data processing apparatus can be configured to receive the conversation data in the form of a text transcript of a conversation from a voice-to-text module. Alternatively, the module can be configured to receive the conversation data in the form of an audio or video signal of the conversation. In an embodiment of a system, in accordance with the invention, there is provided an audio recordal apparatus for recording a conversation. The apparatus can form part of a recording system arranged in a conference room or office. Alternatively, the apparatus can form part of a microphone arrangement used during online conferences between participants. Examples of monitoring and recording meetings are provided in '020, particularly in the background of that disclosure.

At step 14, elements of the organisational knowledge in the conversation data are detected. The way that the elements are detected is described below. In addition, '020 describes various ways in which conversation data can be detected, processed, and analysed.

At step 16, sets of candidate knowledge tuples are extracted from the conversation data. Each candidate tuple can include a sequence of any number of elements that represent respective words and phrases that together describe an item of organisational knowledge. The tuples in each set can describe respective versions of the same item of organisational knowledge.

The elements of organisational knowledge may be in the form of hierarchical attributes of the item of organisational knowledge, such as a broad or top-level category or type, a sub-category, and a detail of that item.

For example, a programmatic message tuple may be extracted as:

{“Programmatic Message”, “Advertising & Marketing”, “Please visit our
store this week to see our range of items on sale”}.

Similarly, an example of a product tuple may be extracted as:
{“Computer Peripherals”, “Brand X”, “Three button mouse”}.

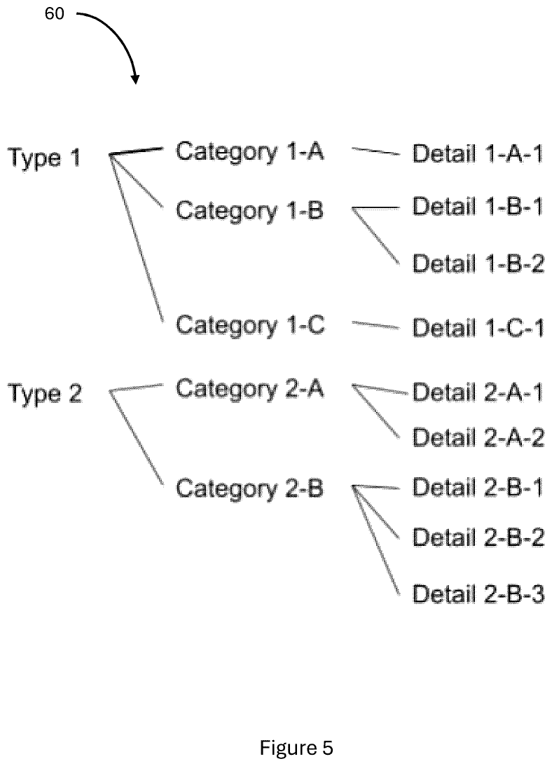

Candidate tuples can be counted. Candidate graph nodes for the graph can be created corresponding to all candidate tuples occurring more than a threshold count across a set of conversations. When the edges encode hierarchical relationships, tuples can be processed first to create nodes for all the top-level categories, then sub-categories within these, and then the detailed nodes linked within these. These can be the different “Types”, “Categories”, and “Details” shown in the graph of FIG. 5.

The method includes the step of progressively merging candidate nodes from each set of candidate tuples to reduce duplication caused by variations in how the same element of organisational knowledge occurs in conversation data. This is done by clustering the set of nodes representing an element of organisational knowledge into a single retained or exemplar node. The final retained nodes are represented by the highest occurring exemplar nodes for the respective elements of organisational knowledge. The data represented by the respective nodes in each set are stored as metadata attached to the associated exemplar node.

The fact that the elements of organisational knowledge manifest in recurring words and phrases across multiple conversations allows the building of a reliable model. It follows that a model can be inferred from data without requiring prior knowledge or explicit user input.

For example, hold messages for a given organisation can occur verbatim across many conversations. Thus, detecting the longest common sequences of words across a large set of conversations can be a reliable way of identifying candidate sentences for hold messages.

In a similar way, while many named entities, such as product names or brands, can occur in a set of conversations, it is likely that the products and services that are characteristic of that organisation will occur more commonly than any other terms. This facilitates the identification of the words or phrases that represent those products and services.

Further characteristics can be used to help distinguish this organisational knowledge automatically from surrounding conversational data. For example, programmatic message content can typically be “read speech” rather than conversational in nature, meaning it will have more consistent grammatical structure and minimal disfluencies. Also, pre-recorded messages will typically be spoken in voices and audio environments that are distinct from those of the main conversation.

Preferred embodiments of a method and a system create or build a graph for an organisation automatically by analysing data from conversations. The graph is configured to encode organisational knowledge that occurs in conversations, such as a telephone call between an employee and a customer. Nodes of the graph correspond to individual elements of organisational context, such as a sentence in a hold message, the name of a product or service, or roles and departments. The graph encodes relationships between these nodes, such as linking individual product models within a given brand. In turn, multiple brands can be joined together under different product types. The graph is constructed automatically from a set of candidate knowledge tuples by analysing occurrence counts and variations of the individual elements of organisational knowledge across a set of conversations.

Preferred embodiments of a computer-implemented method for building a graph of organisation-specific knowledge comprise the following steps set out in FIG. 1:
a) receive conversation data (step 12),
b) detect elements of organisational knowledge in the conversation data (step 14),
c) extract candidate tuples by identifying and extracting candidate words, phrases or sentences that may be elements of organisational knowledge (step 16),
d) initialise a graph by using candidate tuples that occur over a threshold number of times and reflecting relationships between these, the elements of the candidate tuples representing candidate nodes of the graph (step 18).
e) clustering sets of the candidate nodes representing respective elements of organisational knowledge to establish exemplar nodes and to reduce redundancy caused by variations in how a given element of organisational knowledge manifests in conversation data (step 20), and
f) progressively merging the exemplar nodes into nodes of the graph (step 22).

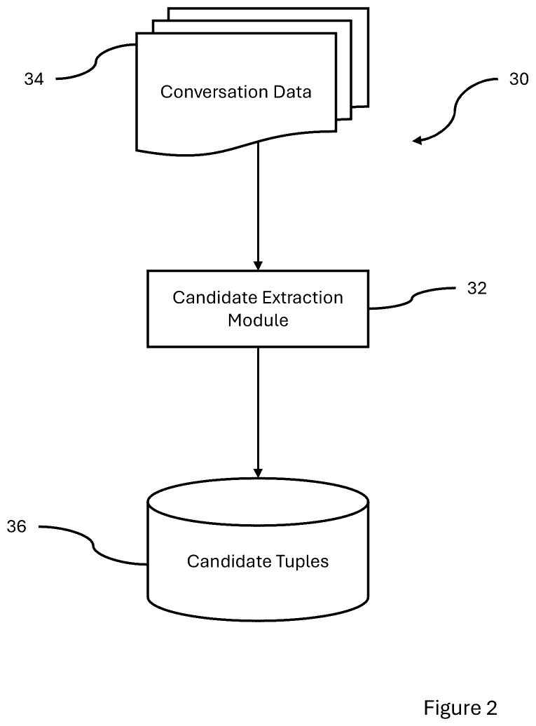

In FIG. 2, reference numeral 30 generally indicates a block diagram showing the use of a candidate extraction module 32 of the system 100 for extracting candidate tuples from conversation data, in an embodiment of the computer-implement method.

The candidate extraction module 32 is configured so that, when executed, it extracts words, phrases, or sentences that may represent different elements of organisational knowledge from conversation data 34. The module 32 uses language model classifiers to identify such elements. Examples of such classifiers are described in '020. The elements of organisational knowledge are described above.

The relationship between the elements of organisational knowledge in each candidate tuple is hierarchical. Each candidate tuple can be a 3-tuple, or triplet, wherein a first element describes a broad category or type of organisational knowledge, a second element describes a sub-category of organisational knowledge, and a third element describes a detail of that organisational knowledge.

For example, a programmatic message tuple may be extracted as:

{“Programmatic Message”, “Advertising & Marketing”, “Please visit our
store this week to see our range of items on sale”}

Similarly, a product tuple may be extracted as:
{“Computer Peripherals”, “Brand X”, “Three button mouse”}

The extracted candidate tuples are stored in a database 36.

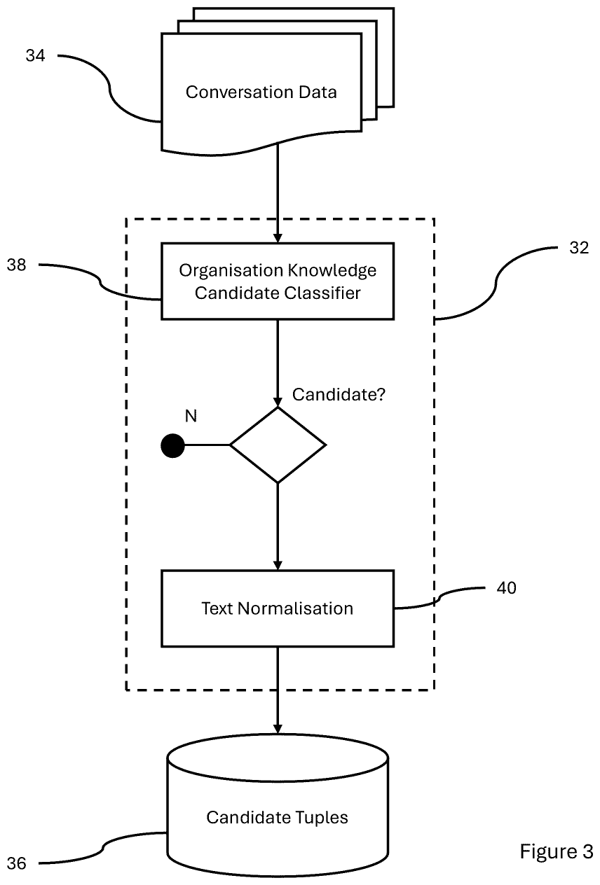

In FIG. 3, the candidate extraction module 32 is shown in more detail.

The module 32 includes a classifier module 38 that can be one or more of:
commonly available Natural Language Processing algorithms including a Part of Speech Parser and a Named Entity Tagger that are configured to process a conversation transcript to annotate elements of organisational knowledge such as names of candidate products, services, departments, people, etc.,
a supervised classifier, such as a neural network, which is trained to discriminate between programmatic message sentences and normal conversational speech sentences by using an annotated set of sentences from known messages as well as normal conversational speech,
a generative large language model that is configured to be prompted to respond with:
   a list of elements of organisational knowledge that occur in a conversation transcript, such as products and services,
   a list of tuples that indicate the category, sub-category and details of any element of organisational knowledge in the call, such as a product type, brand and model,
   a list of sentences in a transcript that are likely to come from a programmatic message such as hold messages,
   any other elements of organisational knowledge detected in the conversation transcript.

The module 32 is configured to provide a large set of candidates for frequency analysis and clustering in subsequent stages. Thus, the classifier module 38 can be tuned to have a low False Rejection Rate, potentially at the expense of a higher False Alarm Rate. Thus, the resulting candidate tuples can include a range of words, phrases or sentences that might not accurately represent true elements of organisational knowledge, requiring these to be filtered out in subsequent stages.

The module 32 includes a text normalisation module 40. The text normalisation module 40 is configured to perform a set of standard operations to ensure text is in a standard form for upstream comparisons. This may include one or more of:
conversion to lowercase,
stemming,
whitespace trimming, and
stop word removal.

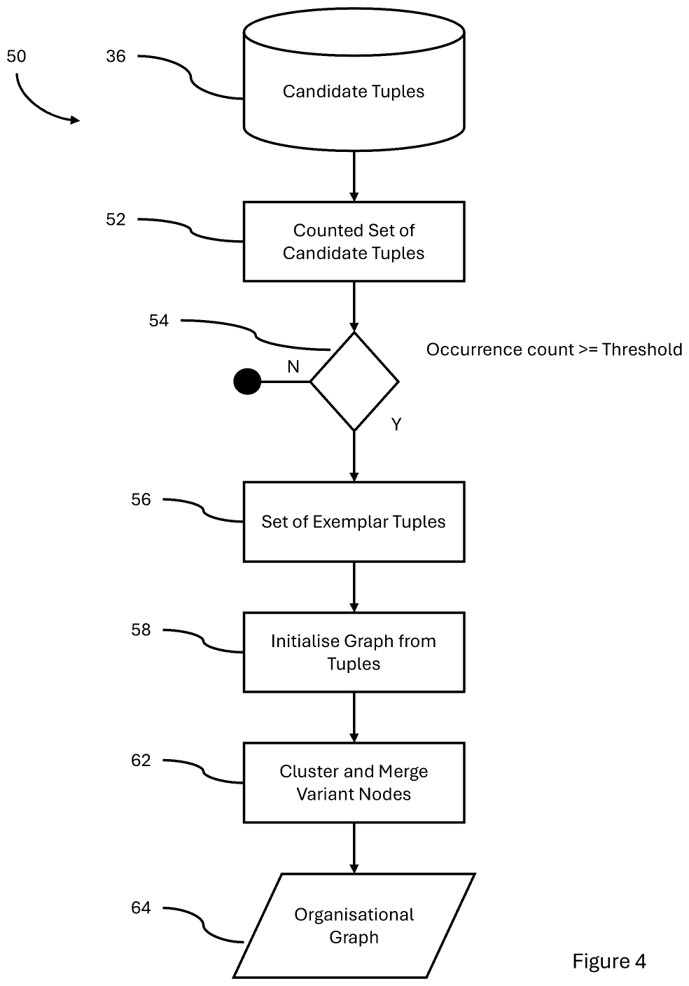

In FIG. 4, reference numeral 50 generally indicates a flowchart of one embodiment of a computer-implemented method for initialising a graph from candidate tuples stored in the database 36.

The candidate tuples in the database 36 may include sets of candidate tuples that represent respective elements of organisational knowledge. The elements in each set vary due to mistranscriptions, variations in acoustic conditions, or different message timing within a call, etc. Also, there may be extracted candidate tuples that are insignificant or outliers, such as names of products or brands not associated with the organisation.

To filter out superfluous candidate tuples, the method for initialising the graph uses occurrence statistics to determine exemplar tuples that have the highest probability of containing true elements of organisational knowledge. This is based on the principle that true organisational knowledge will necessarily recur across many conversations for that organisation, and that the most commonly occurring form of a given piece of organisational knowledge is likely to be the most accurate form to be used as reference.

To automatically train the graph, the candidate tuples are obtained from many conversations. As each candidate tuple is extracted, it is added to a counted set of all candidate tuples at step 52. If the same candidate tuple already exists in this counted set in the same form, the count for that element is incremented. If it does not yet exist in the counted set, a corresponding new element is added to the set with a count of 1.

Once all available candidate tuples have been added to the counted set, the elements are ranked by frequency, that is, their occurrence counts across the conversation dataset. At step 54, when an occurrence count of a particular candidate tuple exceeds a threshold, the candidate tuple is added to a set of exemplar tuples at step 56.

In embodiments of the method and system described herein, the threshold is selected to reduce “noise” of terms that appear a small number of times, based on an empirical histogram. For example, the threshold may be determined according to the lowest 20th percentile of occurrence counts in the conversation dataset. As more conversation data is obtained for the relevant organisation over time, the threshold may be updated to track the evolving distribution.

Once the exemplar tuples have been obtained, a graph is created by iterating through the various fields in each exemplar tuple. Generally, each tuple can have the form:
{“Level 1”, “Level 2”, “Level 3”, . . . , “Level N”}

Level 1 can reflect a broad category of organisational knowledge (for example, “Product”). Level 2 can reflect a sub-category of the product (for example, “Product Type”). Level 3 can reflect a further sub-category (for example, “Brand Name”), and so on down to the most detailed level for that piece of knowledge.

The initial graph is created according to the following method or process:
a) form a counted set (step 52) of candidate tuples by identifying all unique tuples and their count as the number of times they occur within the data,
b) determine a minimum occurrence threshold (step 54) that indicates whether the candidate tuple is significant enough for inclusion in the set of exemplar tuples for building the graph,
c) initialise the graph (step 58) by creating a new node for each unique Level 1 field for each candidate tuple from the counted set whose occurrence is greater than the determined threshold, else do nothing,
d) for each candidate tuple with a given Level 1 field, create a Level 2 node connected to the corresponding Level 1 node for each unique Level 2 field, else do nothing,
e) for each candidate tuple with a given Level 1 and Level 2 field combination, create a Level 3 node connected to the corresponding Level 2 node for each unique Level 3 field, else do nothing,
f) continue until all tuple levels have been processed, and
g) for each node, store as metadata the corresponding count from the counted set.

For example, a graph initialisation process starting with the following candidate tuple set:

| | |
|---|---|
| 1. | {“Type 1”, “Category 1-A”, “Detail 1-A-1”} |
| 2. | {“Type 1”, “Category 1-B”, “Detail 1-B-1”} |
| 3. | {“Type 1”, “Category 1-B”, “Detail 1-B-2”} |
| 4. | {“Type 1”, “Category 1-C”, “Detail 1-C-1”} |
| 5. | {“Type 2”, “Category 2-A”, “Detail 2-A-1”} |
| 6. | {“Type 2”, “Category 2-A”, “Detail 2-A-2”} |
| 7. | {“Type 2”, “Category 2-B”, “Detail 2-B-1”} |
| 8. | {“Type 2”, “Category 2-B”, “Detail 2-B-2”} |
| 9. | {“Type 2”, “Category 2-B”, “Detail 2-B-3”} |

will result in a graph 60, as shown in FIG. 5.

The illustration uses generic tuple fields, but for specific types of organisational knowledge, the levels may correspond to types of programmatic messages and the sentences within these, or brands and models of products. For example, specific candidate tuples of the form {“Type”, “Category”, “Detail”} may be: {“Programmatic Message”, “Advertising & Marketing”, “Please visit our store this week to see our range of items on sale”} or {“Computer Peripherals”, “Brand X”, “Three button mouse”}. In this way, for products and services, the developed model may consist of a hierarchy of categories, general products and services, down to specific brands and models. For organisational structures, the developed model may consist of an organisational chart of departments and roles within them.

The usefulness of the graph is that it ameliorates the need for user configuration or prior knowledge of organisational context. This is achieved by exploiting the recurring patterns that distinguish such content within natural conversational speech.

Once the graph has been initialised, a refinement process clusters sets of nodes representing the same element of organisational knowledge and merges these into a single node at 62. This rationalises the initial graph into a more condensed form and allows organisational knowledge to be detected in conversations in a consistent form, irrespective of the way they are expressed or transcribed.

To determine if any two nodes represent the same knowledge, a measure of similarity can be created over a space of elements, either by:
transforming the candidate tuples to vectors in an embedding space and using vector distances or vector cosines, or
deducing similarity via generative large language models.

A model of the graph can then be trained via a clustering approach. This may involve the following steps:
a) determining an occurrence count threshold for which it is assumed that elements above this count are good quality exemplars, and then merging lower occurrence elements into the higher occurrence ones if they meet some similarity conditions, or
b) determining a similarity threshold and merging the most similar elements above some occurrence threshold until no possible mergers lie above the similarity threshold.

The similarity threshold may be determined empirically on a general conversation dataset, or per organisation. As the similarity threshold is used to determine if the concepts in the nodes actually refer to the same piece of organisational knowledge, typically a high threshold will be used, such as cosine similarity above 0.9.

A variation to this merging approach may instead be as follows:
start from the top level of the hierarchy;
for all child nodes:
   produce embeddings of the node names and node descriptions,
   calculate embedding cosine similarities between all node pairs, for node pairs with cosine threshold above a high threshold such as 0.9, send the node name and descriptions to a generative large language model to classify if they are the same or not,
   create a clustering graph with edges between all node pairs classified as representing the same knowledge,
   run a community detection algorithm, such as the Louvain algorithm, on the resulting graph to create disjoint clusters with maximised self-similarity, and
   merge all nodes within each cluster; and
repeat for the next level of the hierarchy.

It will be appreciated that, when applying the variation to the hierarchy illustrated in the graph 60, the process would start with the “Types”. The child nodes would be the “Categories”, and grandchild nodes would be “Details”. Thus, once relevant Categories are clustered, relevant Details can be clustered. More broadly, using the terminology employed above, the clustering process would start with Level 1, followed by Level 2, etc.

After the merging process is done, there may be some elements left that fall below both the occurrence and similarity thresholds. Those elements can be returned to the counted set or discarded.

Once clustering is finished, the highest occurring exemplar in that cluster is taken as the exemplar node, and then the remaining nodes from that cluster are associated with that exemplar node as metadata allowing them to be matched in a subsequent detection process. The remaining nodes can then be pruned from the graph, reducing its complexity.

Following the above cluster and merge process, a resultant graph is generated at step 64 and can be stored for use in detecting elements of organisational knowledge in new conversations.

The graph can be continually updated as subsequent conversational data are captured following the processes described above. This can be done in a batched mode, once a certain number of new conversations are available, or individually as each new conversation occurs. Any candidate tuples found in a first stage of this updating process will first be aligned to see if corresponding exemplar nodes exist in the graph. If the nodes exist, the occurrence statistics are updated (step 54). If such nodes do not yet exist, the candidate tuple is added to the counted set of candidate tuples (step 52). Once the occurrence count for that candidate element exceeds the threshold that is determined as described above, the associated nodes can be added to the graph as above.

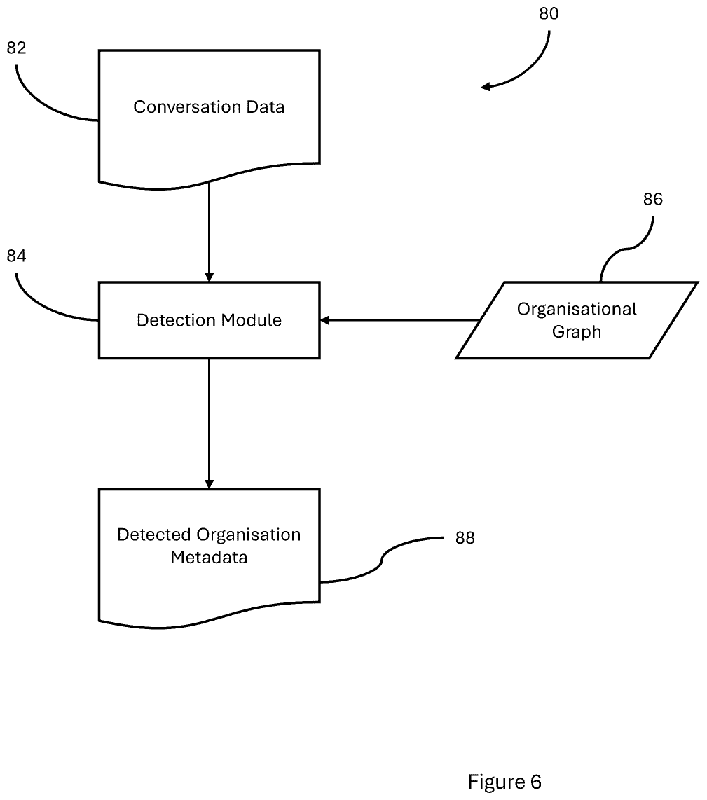

In FIG. 6, reference numeral 80 generally indicates a block diagram representing an embodiment of a method or process for using a graph 86 built according to the process described above.

The process 80 takes new conversation data 82 as input. The process 80 uses a detection module 84 that is configured to execute a matching function to determine whether the conversation data 82 include any elements of organisational knowledge represented as nodes in the graph 86. Such elements are output as metadata 88 associated with the conversation data 82.

Matching functions may use the same similarity measure adopted in the step 62, such as simple keyword matching, embedding vector distances, or a prompt to a language model to determine similarity. Various similarity measures are described in '020.

For example, in the case of programmatic messages that can occur as long sentences, one instantiation of the matching function may compute similarity between TF-IDF (term frequency; inverse document frequency) vector representations of test elements of organisational knowledge from the transcript and exemplar elements of organisational knowledge from the graph in the following steps:
a) using an NLP tokenizer or embedding network to convert the transcript and exemplar elements of organisational knowledge into vectors of length M, representing the number of possible tokens,
b) converting N exemplar elements of organisational knowledge into numerical TF-IDF form to generate an N×M matrix,
c) converting T transcription elements of organisational knowledge into numerical TF-IDF form to generate a T×M matrix, and
d) computing the similarity between the matrices.

The step of computing the similarity between the matrices includes the step of computing a cosine similarity between all combinations of transcript and exemplar elements of organisational knowledge.

Sparse matrix representations can be used to maximise speed and efficiency, and minimise memory use, when carrying out the above steps.

In FIG. 8, reference numeral 100 generally indicates an embodiment of a system for building and using a graph of organisation-specific information from conversation data.

The system 100 includes a conversation signal input device, such as an audio recordal apparatus 102. The apparatus 102 can take various forms. For example, the apparatus 102 can be a microphone or an array of microphones used in a meeting place to detect signals from a meeting. Alternatively, the apparatus 102 can be a microphone used in an online conference call or a meeting between two or more participants.

The audio recordal apparatus 102 is connected to an input server 104 that is configured to store audio data representing the signals received from the apparatus 102. Alternatively, or in addition, the input server 104 is configured to transcribe the audio data into text data. Thus, the conversation data 82 can be stored by the input server as either audio or text data, or both.

The input server 104 is connected to a network 106 so that the conversation data can be read by an output server 108 over the network 106. The network 106 can be in the form of a LAN or can be the Internet. Thus, the input server 104 and the output server 108 can be cloud servers.

The output server 108 is configured to store the database 36 containing the candidate tuples. The output server 108 is configured to store and execute the candidate extraction module 32 to carry out the steps 52 to 64 described above with reference to FIG. 4 and to store the resultant graph. The output server 108 is also configured to execute the detection module 84 and to store the resultant organisation metadata to be used to annotate the organisation metadata.

The system 100 includes user terminals or computers 110 that are connected to the network 106 to facilitate communication with the output server 108 so that annotated conversation data generated by the system 100 can be provided to users of the computers 110.

It is to be noted that the servers 104, 108, can be in the form of a single computing device, or several distributed devices. That is, the servers 104, 108 need not be physically separated.

FIG. 8 shows a schematic of one embodiment of an apparatus for creating and using a graph of organisation-specific information from conversation data.

The apparatus is an electronic processing device 200. The device 200 includes processing circuitry and components that define at least one processor, for example, a microprocessor 202, a memory 204, an external interface 206, and an input/output interface 208, that are interconnected via a bus 210. The interface 206 can be used for connecting the device 200 to peripheral devices, such as communication networks, wireless communications connections, databases, such as the databases 34, 36, 82, 88, other storage devices, signal capture devices, such as the audio recordal apparatus 102, a display, or the like. Although a single external interface 206 is shown, this could be in the form of multiple interfaces.

In use, the microprocessor 202 executes instructions in the form of applications software stored in the memory 204. The applications software can include one or more software modules, including the candidate extract module 32 and the detection module 84.

The device 200 may be formed from any suitable data processing apparatus or system.

The various steps of the embodiments of the computer-implemented method can be split amongst multiple processing systems 200 in geographically separate locations. In some cases, they can be performed by distributed networks of processing systems 200, and/or processing systems provided as part of a cloud-based architecture and/or environment.

In the context of a system for capture, retrieval and browsing of conversation data, applications of the method include those set out below.
Allowing a user or other systems to disregard content, such as hold messages, which are not relevant to the actual conversation by, for example:
   facilitating playback by skipping past hold messages or other programmatic content, and
   optimising the quality of conversation intelligence (such as the moments, summaries, etc., described in '020) by ignoring captured content that is not relevant to the actual conversation.
Allowing a conversation to be linked to organisational knowledge in an information management system, such as finding all conversations about a particular product or service offered by the organisation.

The embodiments of the computer-implemented method and system described herein have many applications in the management and control of organisational knowledge.

A flat text representation of a Complaints knowledge graph may be as follows:

| 1. Complaint: 7891 | |
|---|---|
| 1.1. Customer service: 1802 | |
| 1.1.1. | Lack of follow up: 396 |
| 1.1.1.1. | Lack of communication and follow up: 126 |
| 1.1.1.2. | Lack of order status updates: 16 |
| 1.1.1.3. | (et cetera) |
| 1.1.2. | Communication issue: 1026 |
| 1.1.2.1. | Lack of communication: 562 |
| 1.1.2.2. | Hassle of contacting organisation: 2 |

A flat text representation of a Product knowledge graph may be as follows:

| 1. Product: 37511 | |
|---|---|
| 1.1. Electronics: 33490 | |
| 1.1.1. | Audio equipment: 1666 |
| 1.1.1.1. | Sound Max: 45 |
| 1.1.1.1.1. | Pro Sound Bar: 27 |
| 1.1.1.1.2. | 5000: 7 |
| 1.1.1.2. | Bose: 7 |
| 1.1.1.3. | Unknown: 327 |
| 1.1.1.3.1. | Wireless earbuds: 92 |
| 1.1.1.3.2. | Sound Max 5000: 6 |
| 1.1.1.3.3. | (et cetera) |
| 1.1.2. | Televisions: 906 |
| 1.1.2.1. | Electrozone: 15 |
| 1.1.2.1.1. | 65-inch smart TV: 10 |
| 1.1.2.2. | Unknown: 830 |
| 1.1.2.2.1. | 65-inch smart TV: 378 |
| 1.1.2.2.2. | 50-inch smart TV: 418 |
| 1.1.2.2.3. | 75-inch OLED TV: 16 |
| 1.1.2.2.4. | (et cetera) |
| 1.1.3. | (et cetera) |

In the above representations, the number is the occurrence count obtained when building the knowledge graph, as described above.

A flat text representation of a Call Motivation knowledge graph may be as follows:

| | |
|---|---|
| 1. | Call Motivations |
| | 1.1.1. Product Enquiries: 1200 |
| | 1.1.1.1. Product availability enquiries: 450 |
| | 1.1.1.2. Product Demonstrations and Trials: 212 |
| | 1.1.1.3. Product Comparisons: 198 |
| | 1.1.1.4. Product Recommendations: 137 |
| | 1.1.1.5. (et cetera) |
| 1.1.2. | Technical Support: 317 |
| 1.1.2.1. | Hardware issues: 158 |
| 1.1.2.2. | Software issues: 123 |
| 1.1.2.3. | (et cetera) |
| 1.1.3. | Store Information: 27 |
| 1.1.3.1. | Store Opening Hours: 20 |
| 1.1.3.2. | Store Directions: 7 |
| 1.1.4. | Sales and Purchases: 540 |
| 1.1.4.1. | Price Negotiation: 312 |
| 1.1.4.2. | Promotional Enquiries: 145 |
| 1.1.4.3. | (et cetera) |

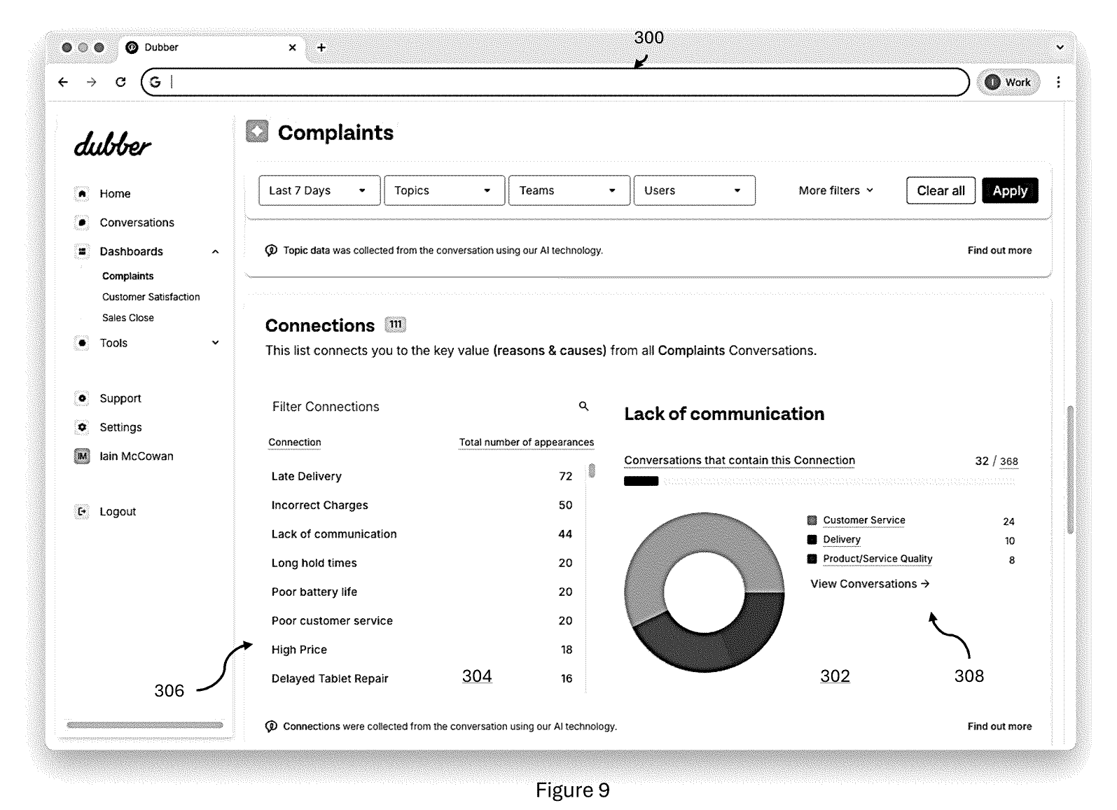

FIG. 9 shows an example of an output that can be generated when using the graph of organisation-specific knowledge, described herein. In this case, the organisation-specific knowledge is related to complaints. The output is in the form of a webpage 300. The webpage 300 includes a field 302 showing a visual representation based on the occurrence count of various categories of complaint, such as customer service, delivery and product/service quality. The field 302 includes a link at 308 to details of relevant conversations relating to complaints.

The webpage 300 also includes a field at 304 that allows a user to connect to reasons and causes of conversations relating to complaints, as shown in a list 306 in the field 304.

Each item in the list 306 shows a category of complaint together with the number of occurrences of that category of complaint. The items in the list 306 can link to further detail so that a user can pinpoint related calls quickly and view summary statistics.

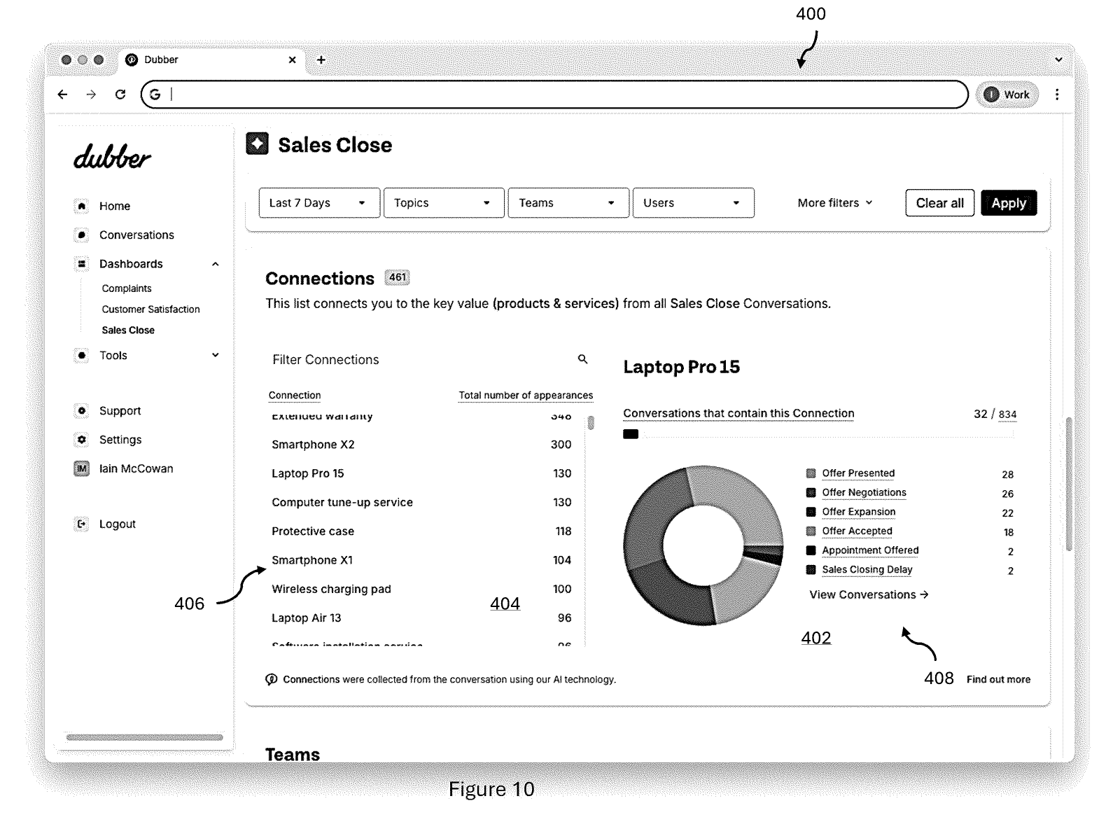

FIG. 10 shows an example of an output that can be generated when using the graph of organisation-specific knowledge, described herein. In this case, the organisation-specific knowledge is related to closed sales. The output is in the form of a webpage 400. The webpage 400 provides a field 402 showing a visual representation based on the occurrence count of various sales processes, such as “offer presented”, “offer negotiations”, “offer expansion”, et cetera. The field 402 includes a link at 408 to details of relevant conversations relating to complaints.

The webpage 400 also includes a field at 404 that allows a user to connect to details of the related products and services, as shown in a list 406 in the field 404.

Each item in the list 406 shows a category of product/service together with the number of occurrences of that category. The items in the list 406 can link to further detail so that a user can pinpoint related calls quickly and view summary statistics.

It will be appreciated that the embodiments of the method and system described herein can be used to generate any number of such outputs to provide users with an efficient manner of obtaining details of relevant conversations relating to various items of organisational knowledge and obtaining statistics related to those items of organisational knowledge.

The appended claims are to be considered as incorporated into the above description.

Throughout this specification, reference to any advantages, promises, objects or the like should not be regarded as cumulative, composite, and/or collective and should be regarded as preferable or desirable rather than stated as a warranty.

Throughout this specification, unless otherwise indicated, “comprise,” “comprises,” and “comprising,” (and variants thereof) or related terms such as “includes” (and variants thereof),” are used inclusively rather than exclusively, so that a stated integer or group of integers may include one or more other non-stated integers or groups of integers.

The term “and/or”, e.g., “A and/or B” shall be understood to mean either “A and B” or “A or B” and shall be taken to provide explicit support for both meanings or for either meaning.

Features which are described in the context of separate aspects and embodiments of the invention may be used together and/or be interchangeable. Similarly, features described in the context of a single embodiment may also be provided separately or in any suitable sub-combination.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

1. A computer-implemented method of building a graph of organisation-specific knowledge, the method comprising the steps of:
receiving conversation data representing at least one conversation;
detecting words and phrases within the conversation data that describe organisational knowledge;
extracting sets of candidate knowledge tuples from the conversation data, each tuple including a sequence of elements that represent respective words, phrases, or sentences that together describe an item of organisational knowledge, the elements in each tuple being ordered according to an ontology of the item of organisational knowledge, and the tuples in each set describing respective versions of the item of organisational knowledge;
creating exemplar tuples that correspond to candidate tuples in respective sets that contain elements that occur more than a threshold number of times in the text;
initialising the graph from nodes representing the elements of the exemplar tuples, and edges representing relationships between the elements; and
progressively determining and merging sets of nodes that represent the same element of organisational knowledge into exemplary nodes of the graph.

2. The computer-implemented method of claim 1, wherein the step of detecting words and phrases within the text that describe the items of organisational knowledge includes the step of using natural language processing to identify the words, phrases or sentences.

3. The computer-implemented method of claim 2, wherein the different types of organisational knowledge may include one or more of the following:
programmatic messages inserted into conversations, along with their type such as on hold messages, IVR responses, legal disclaimers, terms and conditions, etc.;
products or services provided by the organisation;
organisational structure such as departments, roles, and personnel; and
other organisational knowledge that provides context to conversations, such as systems, processes, industry details, partner organisations, etc.

4. The computer-implemented method of claim 2, wherein the step of detecting words and phrases within the text includes the step of using a neural network language model.

5. The computer-implemented method of claim 4, wherein the step of using a neural network language model includes the step of using a supervised classifier that is trained to discriminate between sentences containing organisational knowledge and normal conversational speech sentences by using an annotated set of sentences containing known organisational knowledge as well as normal conversational speech.

6. The computer-implemented method of claim 4, which includes the step of normalising text representing the detected words and phrases to facilitate upstream comparisons.

7. The computer-implemented method of claim 1, wherein the ontology of each item of organisational knowledge is hierarchical such that elements of each candidate tuple are sequenced in hierarchical order with each candidate tuple having the form {“Level 1”, “Level 2”; “Level 3”; . . . , “Level N”}, where Level 1 is a broadest category of the item of organisational information, and Level N is a narrowest category.

8. The computer-implemented method of claim 7, wherein the step of initialising the graph includes the steps of:
a) for each candidate tuple from a counted set of candidate tuples having an occurrence that is greater than the threshold number, creating a new Level 1 node for each unique Level 1 field;
b) for each candidate tuple with a given Level 1 field, creating a Level 2 node connected to a corresponding Level 1 node for each unique Level 2 field;
c) for each candidate tuple with a given Level 1 and Level 2 field combination, creating a Level 3 node connected to a corresponding Level 2 node for each unique Level 3 field;
d) repeating steps (a) to (c) until all tuple levels have been processed; and
e) for each node, storing the corresponding count from the counted set as metadata.

9. The computer-implemented method of claim 1, wherein the nodes that represent the same element of organisational knowledge are associated with the exemplary node as metadata to facilitate matching in subsequent detection processes and are subsequently pruned from the graph to reduce its complexity.

10. The computer-implemented method of claim 1, wherein a determination of whether any two nodes represent the same element of organisational knowledge is carried out by transforming the associated candidate tuples into vectors in an embedding space and measuring a distance between the two vectors or measuring cosine similarity between the two vectors.

11. The computer-implemented method of claim 1, wherein a determination of whether any two nodes represent the same element of organisational knowledge is carried out by deducing similarity using neural network language models.

12. The computer-implemented method of claim 1, wherein a model of the graph is trained by:
a) determining an occurrence count threshold for which it is assumed that elements of organisational knowledge above this count are good quality exemplars; and
b) merging lower occurrence elements into the higher occurrence elements if predetermined similarity conditions are met.

13. The computer-implemented method of claim 1, wherein a model is trained by:
a) determining a similarity threshold; and
b) merging the most similar elements above a predetermined occurrence threshold until no possible mergers lie above the similarity threshold.

14. A method of determining organisational knowledge using a comprising the steps of:
building a graph of organisation-specific knowledge that includes the steps of:
receiving conversation data representing at least one conversation;
detecting words and phrases within the conversation data that describe organisational knowledge;
extracting sets of candidate knowledge tuples from the conversation data, each tuple including a sequence of elements that represent respective words, phrases, or sentences that together describe an item of organisational knowledge, the elements in each tuple being ordered according to an ontology of the item of organisational knowledge, and the tuples in each set describing respective versions of the item of organisational knowledge;
creating exemplar tuples that correspond to candidate tuples in respective sets that contain elements that occur more than a threshold number of times in the text;
initialising the graph from nodes representing the elements of the exemplar tuples, and edges representing relationships between the elements; and
progressively determining and merging sets of nodes that represent the same element of organisational knowledge into exemplary nodes of the graph;
providing a transcript representing the at least one conversation;
detecting elements of organisational knowledge in the transcript by performing a matching function to measure a similarity between the elements of organisational knowledge in the transcript and the elements of organisational knowledge represented by the nodes of the graph; and
outputting detected elements of organisational knowledge as metadata associated with the at least one conversation.

15. The method of claim 14, wherein the step of performing the matching function includes the step of computing a similarity between TF-IDF vector representations of test elements of organisational knowledge from the transcript and exemplar elements of organisational knowledge from the graph.

16. The method of claim 15, wherein the step of computing the similarity between the TF-IDF vector representations includes the steps of:
a) using an NLP tokenizer or embedding network to convert the transcript and exemplar elements of organisational knowledge into vectors of length M, representing a number of possible tokens;
b) converting N exemplar elements of organisational knowledge into numerical TF-IDF form to generate an N×M matrix;
c) converting T transcription elements of organisational knowledge into numerical TF-IDF form to generate a T×M matrix; and
d) computing the similarity between the matrices.

17. The method of claim 16, wherein the step of computing the similarity between the matrices includes the step of computing a cosine similarity between all combinations of transcript and exemplar elements of organisational knowledge.

18. The method of claim 16, wherein the step of computing the similarity between the matrices is carried out using sparse matrix representations.

19. A system for building a graph of organisation-specific knowledge, the system comprising:
a non-transitory computer-readable medium with instructions encoded thereon; and
one or more processors configured to, when executing the instructions, perform operations of:
receiving conversation data representing at least one conversation;
detecting words and phrases within the conversation data that describe organisational knowledge;
extracting sets of candidate knowledge tuples from the conversation data, each tuple including a sequence of elements that represent respective words and phrases that together describe an item of organisational knowledge, the elements in each tuple being ordered according to an ontology of the item of organisational knowledge, and the tuples in each set describing respective versions of the item of organisational knowledge;
creating exemplar tuples that correspond to candidate tuples in respective sets that contain elements that occur more than a threshold number of times in the text;
initialising the graph from nodes representing the elements of the exemplar tuples; and
progressively determining and merging sets of nodes that represent the same element of organisational knowledge into exemplary nodes of the graph.

20. A computer program product comprising a non-transitory computer-readable storage medium containing computer program code, the computer program code, when executed by one or more processors causing the one or more processors to perform operations, the computer program code comprising instructions to:
receive conversation data representing at least one conversation;
detect words and phrases within the conversation data that describe organisational knowledge;
extract sets of candidate knowledge tuples from the conversation data, each tuple including a sequence of elements that represent respective words and phrases that together describe an item of organisational knowledge, the elements in each tuple being ordered according to an ontology of the item of organisational knowledge, and the tuples in each set describing respective versions of the item of organisational knowledge;
create exemplar tuples that correspond to candidate tuples in respective sets that contain elements that occur more than a threshold number of times in the text;
initialise the graph from nodes representing the elements of the exemplar tuples; and
progressively determine and merge sets of nodes that represent the same element of organisational knowledge into exemplary nodes of the graph.
